(19) United States
(12) Patent Application Publication
(10) Pub. No.: US 2011/0173267 A1
(43) Pub. Date: Jul. 14, 2011

(54) Spoken email-audio file integrated with text message as a new way of email for communication

(76) Inventor: Hong Liu, Whitestone, NY (US)

(21) Appl. No.: 12/657,063

(22) Filed: Jan. 13, 2010

(51) Int. Cl. G06F 15/16; G10L 15/26

(52) U.S. Cl. 709/206; 704/235; 704/E15.043

(57) ABSTRACT

A method of creating, transferring and comprehending the audio file integrated with text message in email system as a new way of email for communication. It makes working with email much more efficient, faster, and healthier. It greatly reduces the workload in typing and reading the traditional email. It also helps people who couldn't read and write much to use email system for communication.

### BACKGROUND OF THE INVENTION

This invention—Spoken Email, pertains to a new and enhanced way for email communication. It is a method of creating an audio file integrated with the traditional text message generated by the audio speech. It saves a great deal of people's time working with emails. It is much more healthier and faster in application than traditional email as people typing much less and reading much less when communicating with it.

Email becomes more and more important in people's daily life, especially for working people in all industries. They create emails via typing and read emails with their eyes. These exhaust their hands and eyes everyday and can be very time-consuming as well if you have hundreds of emails to write and read daily.

### SUMMARY OF THE INVENTION

It is therefore an object of this invention to provide an improved, more convenient, efficient and healthier method of creating, comprehending and replying email. Instead of writing an email via typing, this invention utilizes the audio/sound to text converting software as well as audio recording software available at the current marketplace, together with the built-in or plugged in microphone in the device (computers, cellular phones, etc.), to create an audio file and text message of the same content at the same time. These audio file and text message integrated with each other as one email and being sent to the receiver simultaneously. Upon receipt of the Spoken Email, the receiver has the option of either listen to the email or read it. The receiver also has the option of replying to the Spoken Email either via typing in the traditional way, or by creating another Spoken Email.

Utilizing the text to speech software available at the current marketplace, an incoming email received in traditional format can be converted into a Spoken Email as well, with integrated audio file added to the traditional incoming email received. Thus, enable people to listen to the email received, instead of reading it, and reply to it by either typing in the traditional way, or creating another Spoken Email.

By using Spoken Email in people's everyday life, a great deal of time and energy can be saved. The workload of typing with hands and reading with eyes can be reduced to a great degree. Meanwhile, a copy of text messages can also be kept and saved as records and evidence for future reference.

### DETAILED DESCRIPTION OF THE INVENTION

This invention adds audio function to the current email system. When initiating or replying to, an email, in the drafting interface in various email systems, people speaks to the microphone that is either built into, or plugged into the device (computers, cell phones, etc). With audio/sound to text converting software and audio recording software available at the current marketplace, working together with email system, people's speech is recorded and generated an audio file, as well as a separate text message of the same content of the speech in words. The audio file will be attached to the text message of speech and these two integrated with each other as one integrated draft. Then the integrated draft will be sent, thus creating a Spoken Email.

An incoming email received in traditional format can be converted into a Spoken Email—an integrated email with audio file attached to the text message, utilizing the text to speech software available at the current marketplace. Thus enable people to listen to the email received, instead of reading it, and reply to it by either typing in the traditional way, or creating another Spoken Email.

When people receive the Spoken Email—email with both Audio file and text message of the same content integrated with each other, they can either listen to it by playing the audio file, or read it in the traditional way. They can reply to the Spoken Email by creating and sending another Spoken Mail or reply to it by typing and sending a text message.

By using the Spoken Email, a great deal of time will be saved as there is much less typing and reading needed compared to the traditional emails. Meanwhile, besides the audio files, there is also a copy of text messages saved and kept like the traditional emails, leaving records and evidences for future reference. It can help a lot to the people who couldn't read and write much as well.

I claim:

1. A method of creating, transferring and comprehending the audio file integrated with text message in email system as a new way of emails for communication.

2. A method of converting the traditional text email into audio file attached text message in email system as a new way of email for comprehending and transferring.
